(19) United States
(12) Patent Application Publication
(10) Pub. No.: US 2020/0220245 A1
(43) Pub. Date: Jul. 9, 2020

(54) Waveguide Interconnection with Glide Symmetrically Positioned Holes for Avoiding Leakage

(71) Applicant: Telefonaktiebolaget LM Ericsson (publ), Stockholm (SE)

(72) Inventors: Astrid Algaba Brazalez, Göteborg (SE); Lars Manholm, Göteborg (SE); Oscar Quevedo-Teruel, Stockholm (SE); Mahsa Ebrahimpouri Hamlkar, Stockholm (SE)

(21) Appl. No.: 16/647,891

(22) PCT Filed: Oct. 13, 2017
(86) PCT No.: PCT/EP2017/076187

§ 371 Date: Mar. 17, 2020

(51) Int. Cl. H01P 3/12; H01P 11/00

(52) U.S. Cl. CPC H01P 3/12; H01P 11/002

(57) ABSTRACT

The embodiments herein relate to a first waveguide comprising a first flange (103a) surrounding an end opening (105a) of the first waveguide (101a). The first flange (103a) comprises at least two holes (110) which are periodically distributed around the end opening (105a). The first waveguide (101a) is arranged to be connected to a second waveguide (101b) by connecting the first flange (103a) to a second flange (103b) of the second waveguide (101b) such that the end opening (105a) of the first waveguide (101a) faces an end opening (105b) of the second waveguide (101b) and such that the holes (110) in the first flange (103a) are at least partly glide symmetrically positioned with respect to holes (110) which are periodically distributed around the end opening (105b) of the second flange (103b).

### BACKGROUND

A waveguide is a device or a guide through which electromagnetic currents are guided. The waveguide typically comprises a hollow tube or pipe, and is therefore also referred to as a hollow waveguide. The hollow tube may be circular, rectangular or have any other suitable shape. The waveguide has a hollow centre and conductive walls defining the centre of the waveguide. The diameter of the waveguide and the wavelength of the electromagnetic wave traveling in the waveguide are closely related in a way that if the frequency of the wave is too low, then the electromagnetic wave cannot propagate through the waveguide.

Hollow waveguides have been widely used as a hardware standard technology for the design of passive microwave components and antenna arrays. They are entirely made of metal and exhibit attractive features like low loss, good isolation properties and high power handling capability. A common application of hollow waveguides is to be used as a standard interconnection interface of high frequency circuits for lab testing purposes. In such cases, the waveguide typically comprises a flange. There are different types of waveguide flanges, and some of them will be described below. The surface of a waveguide flange (e.g. made of metal) should be smooth and clean in order to let the electromagnetic currents suitably flow along the two waveguides joined together without any leakage or reflection. Additional versions of waveguide flanges provide a texture pattern around the waveguide opening to facilitate the flow of electromagnetic currents between the waveguide joints without leaking energy. One example is the choke flange that contains a corrugation that establishes a high impedance condition at the contact point between the flanges that is transformed into a short-circuit at the side-edges of the waveguide opening by using a λ_{g}/4 section. λ_{g} represents the guided (g) wavelength (λ) of the wave propagating in the parallel plate waveguide region between the two flanges. Therefore, the current flows smoothly across the joint between two waveguides without leaking. Another waveguide flange type is the so-called pin-flange adapter where a pin surface surrounding the waveguide opening in one of the flanges avoids any possible power loss when screwed together with a smooth waveguide flange in the presence of a gap between the pin-flange and the smooth flange. See S. Rahiminejad, E. Pucci, S. Haasl, and P. Enoksson, “Micromachined contactless pin-flange adapter for robust high-frequency measurements”, Journal of Micromachining and Microengineering, vol. 24, no. 8, 2014.

An example of a traditional flange of a rectangular waveguide for measurement purposes is illustrated in FIG. 1. The waveguide is referred to as a rectangular waveguide because the opening has a rectangular shape. The left part of FIG. 1 illustrates a waveguide assembly where three waveguides 1101a, 1101b, 1101c are connected together, and the right part of FIG. 1 provides a more detailed illustration of some of the flanges comprised in the waveguide assembly. FIG. 1 illustrates an example where the three waveguides 101a, 101b, 101c are rectangular tubes. As seen in FIG. 1, a first waveguide 101a comprises a first flange 103a surrounding an end opening 105a in one end of the first waveguide 101a. A second waveguide 101b comprises a second flange 103b surrounding an end opening 105b in one end of the second waveguide 101b. The first waveguide 101a is connected to the second waveguide 101b by connecting the first flange 103a to the second flange 103b so that the end openings 105a, 105b face each other. The first and second flange 103a, 103b may be connected to each other by using for example screws or other suitable connecting means. Furthermore, FIG. 1 illustrates that the second waveguide 101b comprises a third flange 103c surrounding an end opening in the opposite end of the second waveguide 101b as compared to the second flange 103b. The second waveguide 101b may be a Device Under Test (DUT). A third waveguide 101c comprises a fourth flange 103d surrounding an end opening of the third waveguide 101c. The third waveguide 101c is connected to the second waveguide 101b by connecting the fourth flange 103d to the third flange 103c. The end openings 105a, 105b are illustrated as a rectangular openings due to that the waveguide is formed as a rectangular tube.

As seen in the right part of FIG. 1, each flange 103a, 103b, 103c, 103d are circular flat disks having a smooth surface and having a respective end opening 105a, 105b in the center of the disk. Each flange 103a, 103b, 103c, 103d is located around the outer circumference of the end part of the respective waveguide 101a, 101b, 101c. The surface of the waveguide flange (e.g. made of metal) should be smooth and clean in order to let the electromagnetic currents suitably flow along the two waveguides joined together without any leakage or reflection. Tolerances or errors when mating to flanges 103 can cause gaps 112 between the flange surfaces. The errors and gaps 112 can be created by screwing the flanges carelessly or not tightening them well. The gaps 112 may cause leakage, reflections and measurement uncertainties.

Both the flat flange and the choke flange need to be carefully mated so ensure a good electrical contact. The term mated may also be described as connected, joined, coupled etc. This is usually done by screwing, which is time consuming and laborious. The pin flange and the choke flange both need very accurate fabrication methods, which limits their use at higher frequencies since the dimensions of the corrugations and the pins become very small. Therefore, there is a need to at least mitigate or solve this issue.

### SUMMARY

An objective of embodiments herein is therefore to obviate at least one of the above disadvantages and to provide an improved waveguide interconnection.

According to a first aspect, the object is achieved by a first waveguide comprising a first flange surrounding an end opening of the first waveguide. The first flange comprises at least two holes which are periodically distributed around the end opening. The first waveguide is arranged to be connected to a second waveguide by connecting the first flange to a second flange of the second waveguide such that the end opening of the first waveguide faces an end opening of the second waveguide and such that the holes in the first flange are at least partly glide symmetrically positioned with respect to holes which are periodically distributed around the end opening of the second flange.

According to a second aspect, the object is achieved by a waveguide assembly for waveguides. The waveguide assembly comprises a first waveguide comprising a first flange surrounding an end opening of the first waveguide. The waveguide assembly further comprises a second waveguide comprising a second flange surrounding an end opening of the second waveguide. Each flange comprises at least two holes which are periodically distributed around the respective end opening. The first and second waveguides are arranged to be connected to each other by connecting the first flange to the second flanges such that the end openings face each other and such that the holes in the first flange are at least partly glide symmetrically positioned with respect to the holes in the second flange.

According to a third aspect, the object is achieved by a method for manufacturing a first waveguide. The method comprises providing a first flange surrounding an end opening to the first waveguide. The first flange comprises at least two holes which are periodically distributed around the end opening. The first waveguide is arranged to be connected to a second waveguide by connecting the first flange to a second flange of the second waveguide such that the end opening of the first waveguide face an end opening of the second waveguide and such that the holes in the first flange are at least partly glide symmetrically positioned with respect to holes which are periodically distributed around the end opening of the second flange.

According to a fourth aspect, the object is achieved by a method for manufacturing a waveguide assembly for waveguides. The method comprises providing a first waveguide comprising a first flange surrounding an end opening of the first waveguide. The method further comprises providing a second waveguide comprising a second flange surrounding an end opening of the second waveguide. Each flange comprises at least two holes which are periodically distributed around the respective end opening. The method further comprises connecting the first and second waveguides to each other by connecting the first flange to the second flanges such that the end openings face each other and such that the holes in the first flange are at least partly glide symmetrically positioned with respect to the holes in the second flange.

An improved waveguide interconnection is provided since each flange comprises at least two holes which are periodically distributed around the respective end opening, and since the first and second waveguides are configured to be connected to each other by connecting the first flange to the second flanges such that the end openings face each other and such that the holes in the first flange are at least partly glide symmetrically positioned with respect to the holes in the second flange.

Embodiments herein afford many advantages, of which a non-exhaustive list of examples follows:

A glide symmetric structure is a periodic pattern generated by two geometrical transformations: a translation and a reflection with respect to a certain reference plane. It has been found that by using holes as unit cell of this glide symmetric structure, a wideband stopband where all higher-order modes are avoided is achieved. When this structure is integrated surrounding a waveguide flange opening, an advantage of the embodiments herein is that any possible leakage of signals with frequencies within the stop band due to a gap between the flange joints is eliminated and a smooth transition is achieved.

Only one row of holes surrounding the waveguide opening is enough to prevent leakage and provides almost perfect transmission, thereby the embodiments herein has an advantage of simplifying the waveguide since it is not necessary to apply several rows of holes in the holey flange configuration as compared to a pin-type flange which has several rows of pins.

Another advantage of the embodiments herein is that the holes can be made by just drilling, which is much simpler and cost-effective than milling pins or corrugations.

There is a minimum required depth of the holes but as long as the depth is larger than the minimum required depth, the depth does not affect the stopband. This provides an advantage of a non-sensitivity tolerance to the depth of the hole. Moreover, the depth of the hole is smaller than the pin height in the pin-flange, which should be around λ/4 (λ represents the wavelength) in order to create an open boundary condition, so the holey flange can be made smaller (thinner) than the pin flange.

A further advantage of the embodiments herein is that the performance of the at least partly glide symmetric holey structure is insensitive to the flatness of the bottom of the hole, which provides manufacturing flexibility since the drill could have a conical shape and the holey flange still performs as expected.

The period and hole dimensions in the embodiments herein are larger than the required ones in a pin-type Electromagnetic bandgap (EBG) structure for operating at the same center frequency. A larger period means an advantage of less sensitivity to manufacturing tolerances and misalignments. For example, at a center frequency of 60 GHz, it has been seen that misalignments of 0.2 mm do not affect its performance.

If the number of holes surrounding the waveguide is even, the holes can be placed in an anti-symmetric topology so that the need of fabricating two different male and female holey flange adapters is avoided. In this way, the embodiments herein have an advantage of that both flanges are manufactured identical and when they are joined together the geometry is built-up at least partly glide symmetrically. This fact simplifies the manufacturing and use since there is only one variant of flange.

The embodiments herein provide the additional advantage of that the at least partly glide symmetric holey flange reduces leakage independently of if the surface of the flange is flat or if it is a bulgy flange.

Furthermore, the embodiments herein provide the advantage of that the at least partly glide symmetric holey pattern reduces any leakage independently on how the holes are distributed around the waveguide opening (the hole topology can be rounded, elliptical, square etc.).

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1 is a schematic drawing illustrating an example embodiment of a waveguide assembly.

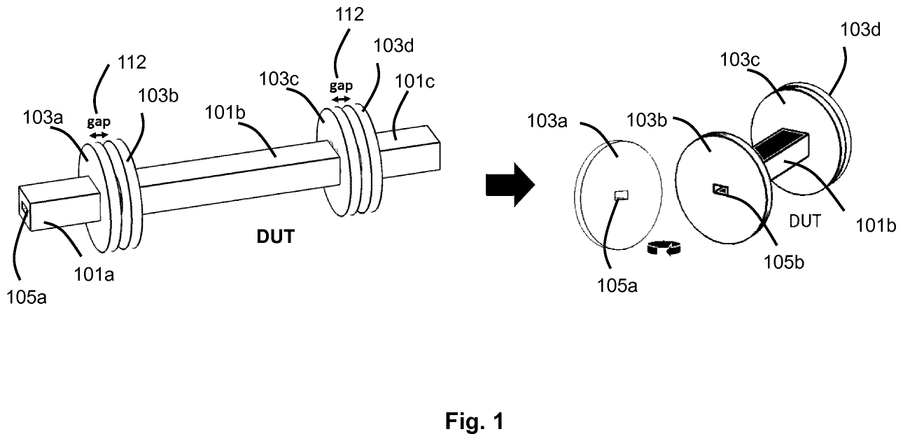

FIG. 2 is a schematic drawing illustrating an example embodiment of a waveguide assembly.

FIG. 3 is a schematic drawing illustrating an example embodiment of the flange.

FIG. 4 is a schematic drawing illustrating an example embodiment of the flange.

FIG. 5 is a schematic drawing illustrating an example embodiment of the flange.

FIG. 6 is a schematic drawing illustrating an example embodiment of the flange.

FIG. 7 is a schematic drawing illustrating an example embodiment of the flange.

FIG. 8 is an example illustration of a holey unit cell and corresponding stopband

FIG. 9 is a graph illustrating the effect in the stopband for gap variations

FIG. 10 is a graph illustrating the transmission in a prior art flange and a flange with a glide symmetric pattern.

FIG. 11 is a flow chart illustrating embodiments of a method.

The drawings are not necessarily to scale and the dimensions of certain features may have been exaggerated for the sake of clarity. Emphasis is instead placed upon illustrating the principle of the embodiments herein.

### DETAILED DESCRIPTION

The embodiments herein relates to a waveguide with an at least partly glide symmetric holey pattern surrounding the waveguide end opening.

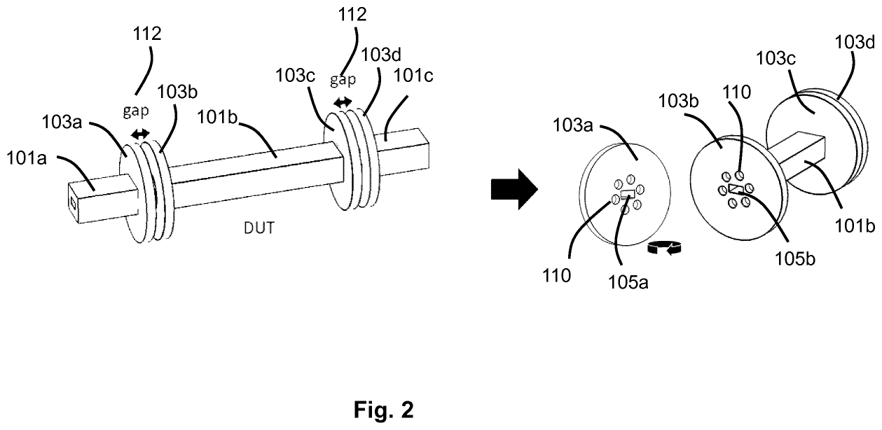

FIG. 2 illustrates an example embodiment of a waveguide assembly. A waveguide assembly may be described as waveguides connected to each other via flanges. The left part of FIG. 2 illustrates a waveguide assembly where three waveguides 101a, 101b, 101c are connected together, and the right part of FIG. 2 provides a more detailed illustration of some of the flanges comprised in the waveguide assembly. FIG. 2 illustrates an example where the three waveguides 101a, 101b, 101c are hollow tubes having a rectangular form, thus the waveguide can be referred to as a hollow waveguide.

As seen in FIG. 2, a first waveguide 101a comprises a first flange 103a surrounding an end opening 105a in one end of the first waveguide 101a. A second waveguide 101b comprises a second flange 103b surrounding an end opening 105b in one end of the second waveguide 101b. The first waveguide 101a is connected to the second waveguide 101b by connecting the first flange 103a to the second flange 103b so that the end openings face each other. Furthermore, FIG. 2 illustrates that the second waveguide 101b comprises a third flange 103c surrounding an end opening in the opposite end of the second waveguide 101b as compared to the second flange 103b. The second waveguide 101b may be a DUT. A third waveguide 101c comprises a fourth flange 103d surrounding and end opening (not shown) of the third waveguide 101c. The third waveguide 101c is connected to the second waveguide 101b by connecting the fourth flange 103d to the third flange 103c. The end openings 105a, 105b are illustrated as a rectangular opening due to that the waveguides 101a, 101b, 101c are formed as rectangular tubes. However, any other suitable shape of the waveguide is applicable such as e.g. a circular tube. The end openings 105a, 105b have a shape which corresponds to the shape of the waveguide (i.e. the tube which the waveguide is comprised of).

When the reference number 101 is used without the letters a, b or c, it refers to any of the waveguides in the assembly. When the reference number 103 is used without the letters a, b, c or d, it refers to any of the flanges in any of the waveguides 101. Similarly, when the reference number 105 is used without the letters a or b, it refers to any of the end openings in any of the waveguides 101.

Considering an example where two waveguides 101 are connected to each other (e.g. the first waveguide 101a and the second waveguide 101b) in an at least partly glide symmetrical way. This means the holes 110 in the first flange 103a are at least partly glide symmetrically positioned with respect to the holes 110 in the second flange 103b. The holes 110 in the first flange 103a are not necessarily directly placed opposite to the holes 110 in the second flange 103b when they are connected, but the holes 110 in the first flange 103a at least partly overlap with the holes 110 in the second flange 103b. In other words, the holes 110 in one flange 103 can glide a certain period with respect to the holes 110 in the other flange 103 when they are connected, e.g. they can glide ½/12-period. The at least partly glide symmetric refers to that the structure may be completely glide symmetric, or quasi glide symmetric. The term quasi glide symmetric refers to having a small deviation from the exact glide symmetric structure, for example it refers to the case that one flange 103 has moved slightly more than half periodicity. Quasi periodic structure refers to the case that the periodicity of the next rows or the dimensions of the holes 110 in next row change slightly. A quasi periodic structure may be described as a structure where the dimensions of the holes 110 changes slightly from flange 103 to flange 103. A quasi periodic structure is a structure that is ordered but not periodic. Thus, the at least partly glide symmetric structure may be referred to as an at least partly quasi periodic structure having complementary holes 110.

Note that the waveguide assembly illustrated in FIG. 2 which comprises three connected waveguides 101a, 101b, 101c is only an example. A waveguide assembly can comprise any other suitable number of waveguides from two and upwards. For example, the waveguide assembly may comprise the first and second waveguides 101a, 101b where the first flange 103a is arranged to be connected to the second flange 103b.

As seen in the right part of FIG. 2, each flange 103 surrounds the end opening 105 of the respective waveguide 101. The end opening 105 may be located substantially in the center of the flanges 103.

Each flange 103 is provided with at least two holes 110 which surround the respective end opening 105. The at least two holes 110 are periodically distributed around the respective end opening 105. Each flange 103 is located around the outer circumference of the end part of the respective waveguide 101. A hole 110 may also be referred to as a groove, recess, aperture, opening, orifice, perforation or slit. The hole has any suitable diameter and depth, and these parameters may be in relation to the frequency band in which the waveguide operates.

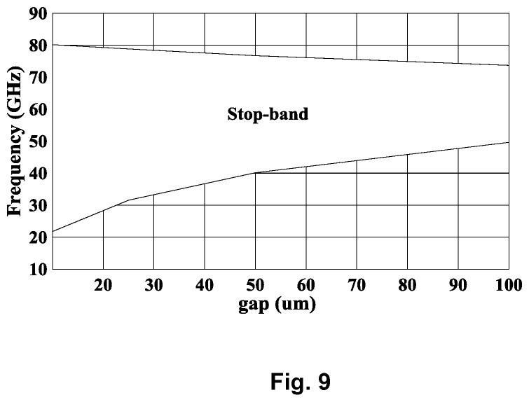

FIG. 2 illustrates that there may be a gap 112 between the flanges 103 when they are connected to each other. In other examples, it is no gap between the connected flanges 103. The gap 112 may be of any length from zero an upwards. By embedding an end opening 105 with one row of holes 110, there is no need to worry about the presence of a small gap 112 when screwing the two flanges 103 together. Nevertheless, it is relevant to remark that the smaller the gap 112 the wider operating bandwidth of the at least partly glide symmetric holey structure we get (see FIG. 9 which is described below).

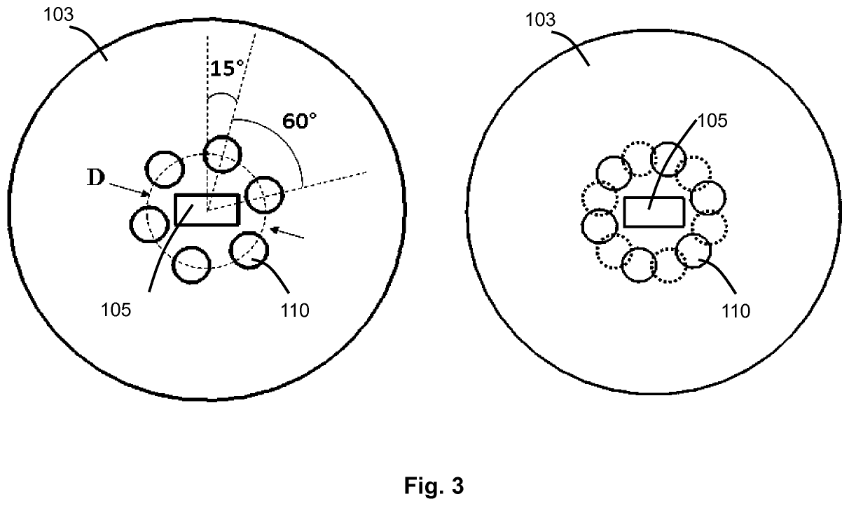

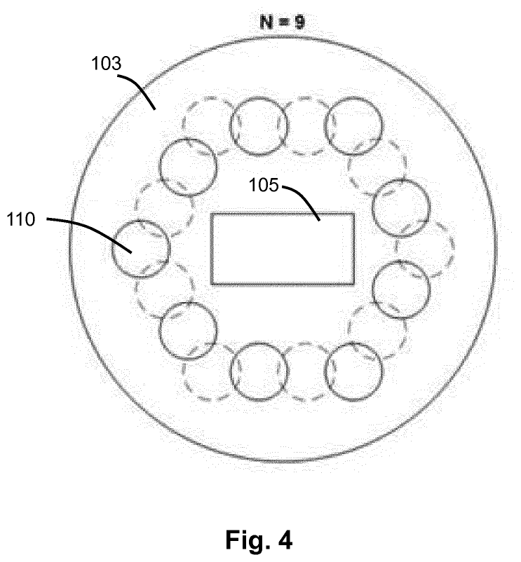

There can be any number of holes 110 from two and upwards and at any distance from the end opening 105. FIG. 3 illustrates an example of a flange 103 having six holes 110. However, each flange 103 may have any other (even or odd) number of holes 110 from two and upwards. The holes 110 drawn with continuous lines are the holes 110 10 located on the flange 103 which is seen in the figure, and the holes 110 drawn with dotted lines are the holes 110 located on the other flange 103, i.e. the flange 103 on the other waveguide 101 which is not shown in the figure. The continuous and dotted drawn holes also apply to FIGS. 4-7 described below. The periodicity of the holes 110 may be dependent on the stopband.

The left part of FIG. 3 illustrates an example of the position of the holes 110, and the right part of FIG. 3 illustrates how the holes 110 in the two mating flanges 103 are placed relative to each other. The holes 110 in FIG. 3 are placed around a circle with diameter of 9 mm. Note that 9 mm is only an example diameter and is for an example frequency of 60 GHz. The diameter can be scaled to any other frequency by scaling all parameters. Another example may be in the U band. See also M. Ebrahimpouri, O. Quevedo-Teruel and E. Rajo-Iglesias, “Design guidelines for gap waveguide technology based on glide symmetric holey structures,” in IEEE Microwave and Wireless Component Letters, vol. 27, no. 6, 2017 for additional details regarding the diameter and frequency. The holes 110 can be positioned at any angle from the center, i.e. the end opening 105. FIG. 3 illustrates an example where the holes 110 are positioned at an angle of 15° from the end opening 105 and where the angle between two neighboring holes 110 is 60°. Specifically, they can be drilled in symmetric topology so that it is possible to avoid fabricating two different topologies to have complementary holes 110 on flange 103 adapters. In this way, both flanges 103 are manufactured identically and when they are joined together the geometry is built-up at least partly glide symmetrically (see the right part of FIG. 3). This fact simplifies the manufacturing process.

The holes 110 can be placed in a circular geometry, as exemplified in FIG. 3, but generally along any closed shape surrounding the end opening 105, e.g. a rectangle, hexagon, or any polygon. FIG. 4 illustrates an example with 19 circular holes 110 on each flange 103, and where the holes 110 are placed in a hexagonal closed shape surrounding the end opening 105.

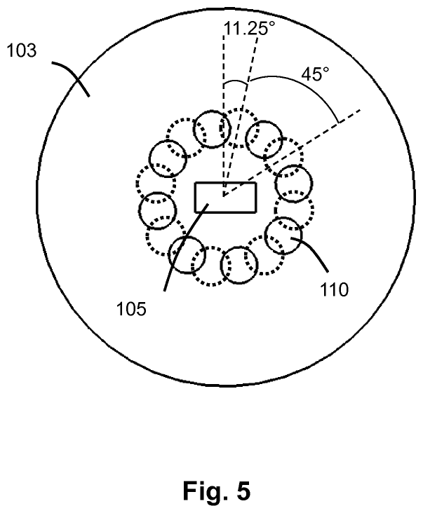

FIG. 5 illustrates an example where each flange 103 comprises 18 holes 110. FIG. 5 also shows an example of the position of the holes 110 on the flanges 103. The rotation angle (i.e. the rotation angle is the angle between the center of one hole 110 and the center of another hole 110 on the same flange 103) and the deviation angle (i.e. the deviation angle is the angle from the center of the flange 103 and the center of a hole 110) associated with the holes 110 can be calculated using the following formulas:

$$Rotation angle = \frac{360 °}{Number of holes on each flange}$$

$$Deviation angle = \frac{\frac{360 °}{Number of holes on each flange}}{4}$$

For 8 holes 110 on each flange 103, the angles may be calculated as follows:

$$Rotation angle = \frac{36 {0}^{°}}{8} = 4 {5}^{°}$$

$$Deviation angle = \frac{\frac{36 {0}^{°}}{8}}{4} = \frac{4 {5}^{°}}{4} = 11.25 °$$

For 6 holes 110 on each flange 103, the angles may be calculated as follows:

$$Rotation angle = \frac{36 {0}^{°}}{6} = {60}^{°}$$

$$Deviation angle = \frac{\frac{36 {0}^{°}}{6}}{4} = \frac{{60}^{°}}{4} = 15 °$$

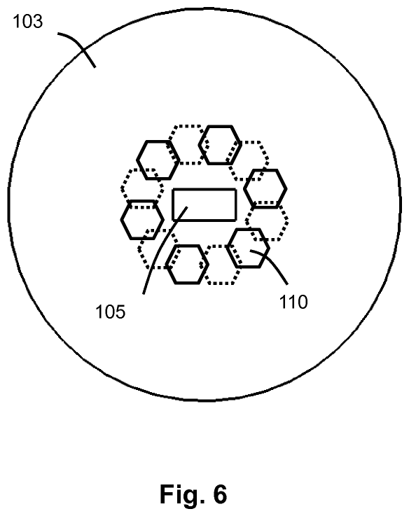

The holes 110 may have any suitable shape. FIGS. 3, 4 and 5 illustrate examples with circular holes 110 and FIG. 6 illustrate an example with hexagonal shaped holes 110. However, the holes 110 may also be triangular, rectangular etc. In FIG. 6, the example number of holes 110 is 6.

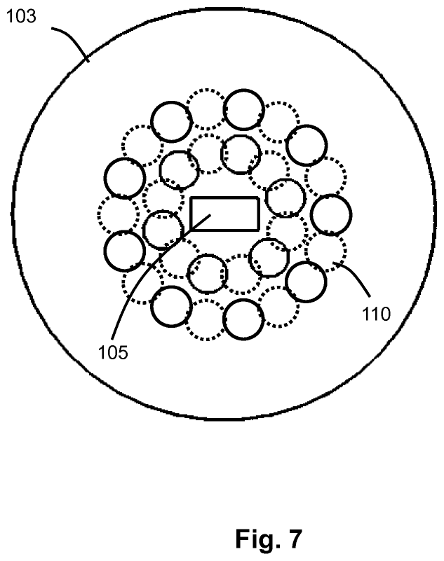

The at least two holes 110 may be distributed in one, two or more rows around the end opening 105. FIGS. 3-6 described above illustrates an example where the holes 110 are distributed in one row around the end opening 105. FIG. 7 illustrates an example where the holes 110 are distributed in two rows around the end opening 105. The inner row (the row being closest to the end opening 105) comprises 16 holes 110 and the outer row (the row being further away from the end opening 105 compared to the inner row) comprises 19 holes 110. Note that two rows of holes 110 is only an example, and that a flange 103 may comprise any suitable number of rows of holes 110 and also number of holes 110.

The holes 110 may be provided to each flange 103 using any suitable method such as drilling, moulding etc.

Each flange 103 may have any suitable shape, for example a circular, rectangular, triangular, hexagonal etc. The flanges 103 on each waveguide 101 are preferably of the same shape. For example, the flanges 103 may be a circular disk having at least two holes 110 on each flange 103.

Each flange 103 may be of any suitable material such as metal, copper, aluminum, brass, gold, silver, metallized plastic or any other suitable material having sufficient electrical conductivity.

The two waveguides 101 are arranged to be connected to each other by connecting e.g. the first flange 103a to the second flanges 103b such that the end openings 105a, 105b face each other and such that the holes 110 in the first flange 103a are at least partly glide symmetrically positioned with respect to the holes 110 in the second flange 103b. The connected first and second flanges 103a, 103b may then be described as mating flanges 103.

The joined flanges 103 having at least two holes 110 that are periodically distributed around the opening may form an EBG structure.

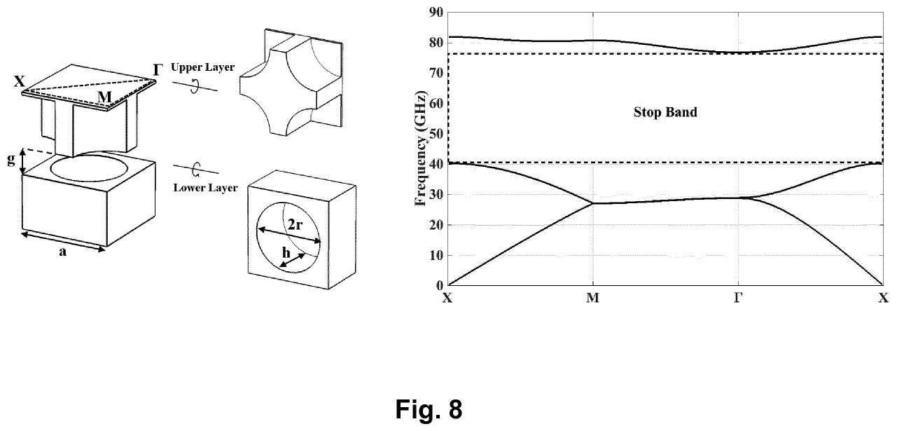

The embodiments herein use an at least partly glide symmetric periodic structure composed of for example a holey-unit cell as exemplified in FIG. 8. A unit-cell may be described as a part of the structure, that when repeated periodically, builds up the complete waveguide 101. For example, the unit cell can be one hole 110 in the first flange 103a plus two halves of two different holes 110 in the second flange 103b. The left part of FIG. 8 illustrates an example of a holey unit cell when a=3.5 mm, 2r=2.8 mm, h=1.5 mm and gap (g) is 0.05 mm. The right part of FIG. 8 illustrates a graph (i.e. a dispersion diagram) with the stopband corresponding to the holey unit cell in the left part. The x-axis of the graph represents the boundaries of a Brillouin zone and the y-axis of the graph represents the frequency measured in GHz. The X, M and gamma in the x-axis correspond to the points shown in the holey unit-cell at the left side of FIG. 8 (they are corners of a Brillouin zone). As seen in FIG. 8, the stopband is between 40 and 77 GHz. The stopband is the band between the dotted lines in FIG. 8. The solid lines in FIG. 8 represent propagating modes (i.e. different orientation of fields), the x-axis is different directions, and it is seen that there exists a frequency band (i.e. the stop band) where no modes can propagate in any direction. As seen, no wave can propagate inside the stop-band.

A stopband may be described as a band of frequencies, between specified limits, through which currents are not allowed to pass.

FIG. 9 is a graph illustrating the effect in the stopband for different gap size variations. The x-axis of FIG. 9 represents the gap 112 measured in pm and the y-axis represents the frequency measured in GHz. With the previous example hole dimensions (i.e. the ones seen in FIG. 8), it is possible to achieve a stopband from 40 to 77 GHz where no waves are allowed to propagate within that air gap 112.

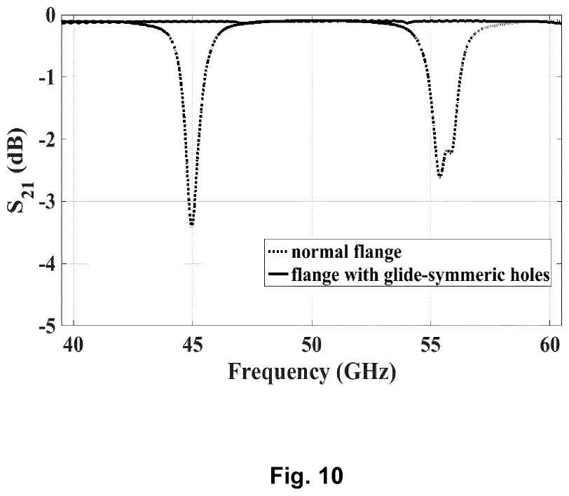

FIG. 10 is a graph illustrating a comparison of the transmission in a prior art flange having a smooth surface and a flange 103 with at least partly glide symmetric holes as in the embodiments herein in case of having a gap 112 of 0.05 mm between the first flange 103a and the second flange 103b. The x-axis of FIG. 10 represents the frequency measured in GHz and the y-axis represents transmission parameter (S₂₁) measured in dB. S₂₁ represents the power transmitted from one waveguide 101 to the other (i.e. not through the gap 112 between the flanges 103). The transmission in the prior art (normal) flange is illustrated with a dotted line and the transmission in the flange 103 with the at least partly glide symmetric holes 112 is illustrated with a continuous line.

Simulations of the scattering parameters of the at least partly glide symmetric flange design will now be described. The performance of the at least partly glide symmetric flange design has been compared with a prior art rectangular waveguide flange. A gap 112 of 0.05 mm between the two flanges 103 is allowed and it is possible to observe in FIG. 10 how the mismatch obtained for the prior art flange is avoided when using the at least partly glide symmetric holey flange 103. The at least partly glide symmetric holey flange 103 creates a smooth transition and all energy between the ports is transmitted without disturbances. Surface roughness caused by manufacturing or assembly tolerances would not affect the performance of the at least partly glide symmetric flange 103 but the operating bandwidth will increase as the gap 112 tends to zero, as it is shown in FIG. 9.

The method for manufacturing a first waveguide 101a according to some embodiments will now be described. The method comprises at least one of the following steps, which steps may as well be carried out in another suitable order than described below:

A first flange 103a surrounding an end opening 105a to the first waveguide 101a is provided. The first flange 103a comprises at least two holes 110 which are periodically distributed around the end opening 105a. The first waveguide 101a is arranged to be connected to a second waveguide 101b by connecting the first flange 103a to a second flange 103b of the second waveguide 101b such that the end opening 105a of the first waveguide 101a face an end opening 105b of the second waveguide 101b and such that the holes 110 in the first flange 103a are at least partly glide symmetrically positioned with respect to holes 110 which are periodically distributed around the end opening 105b of the second flange 103b.

The at least two holes 110 comprised in the first flange 103a may constitute a holey and at least partly glide symmetric EBG structure integrated within the first flange 103a. The at least two holes 110 in the first flange 103a may be placed in a closed shape around the end opening 105a of the first flange 103a. The at least two holes 110 in the first flange 103a may be periodically distributed around the end opening 105a of the first flange 103a in at least one row. Each of the at least two holes 110 on the first flange 103a are at least one of circular, squared or hexagonal shaped.

The at least two holes 110 on the first flange 103a are periodically distributed around the end opening 105a in a circular, a hexagonal or a polygonal form.

The first flange 103a may be located around an outer circumference of the first waveguide 101a.

The first waveguide 101a may be arranged to be connected to a second waveguide 101b such that a gap 112 of zero or more is located between the first flange 103a and the second flange 103b when they are connected.

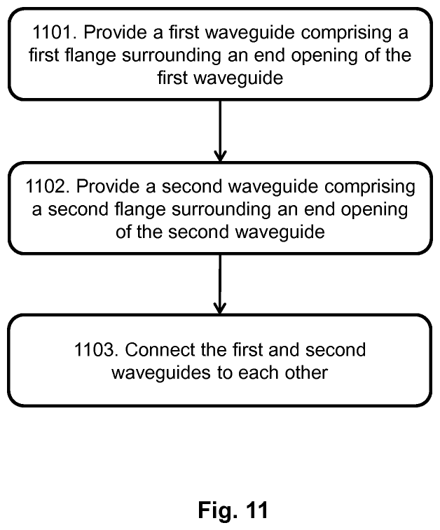

The method for manufacturing a waveguide assembly for waveguides 101, according to some embodiments will now be described with reference to the flowchart depicted in FIG. 11. The method comprises at least one of the following steps, which steps may as well be carried out in another suitable order than described below:

### Step 1101

A first waveguide 101a comprising a first flange 103a surrounding an end opening 105a of the first waveguide 101a is provided.

### Step 1102

A second waveguide 101b comprising a second flange 103b surrounding an end opening 105b of the second waveguide 101b is provided. Each flange 103a, 103b comprises at least two holes 110 which are periodically distributed around the respective end opening 105a, 105b.

### Step 1103

The first and second waveguides 101a, 101b are connected to each other by connecting the first flange 103a to the second flange 103b such that the end openings 105a, 105b face each other and such that the holes 110 in the first flange 103a are at least partly glide symmetrically positioned with respect to the holes 110 in the second flange 103b.

The at least two holes 110 comprised in each flange 103a, 103b may constitutes a holey and at least partly glide symmetric EBG structure integrated within each of the first and second flanges 103a, 103b. The at least two holes 110 in each flange 103a, 103b are placed in a closed shape around the respective end opening 105a, 105b. The at least two holes 110 in each flange 103a, 103b may be periodically distributed around the respective end opening 105a, 105b in at least one row. The at least two holes 110 on each flange 103a, 103b may be at least one of: circular, squared or hexagonal shaped. The at least two holes 110 on each flange 103a, 103b may be periodically distributed around each end opening 105a, 105b in a circular, a hexagonal or a polygonal form.

The first flange 103a may be located around an outer circumference of the first waveguide 101a and the second flange 103b may be located around an outer circumference of the second waveguide 101b.

A gap 112 of zero or more may be located between the first flange 103a and the second flange 103b when they are connected.

Some embodiments described herein may be summarised in the following manner: A waveguide flange where a holey at least partly glide symmetric EBG structure is integrated within a waveguide flange 103. Thus, the flange 103 may be referred to as a holey and at least partly glide symmetric flange 103. The holey at least partly glide symmetric flange 103 is placed surrounding the waveguide end opening 105 and significantly reduces the leakage, should there be a gap 112 between the mated flanges 103. This waveguide 101 is easier to manufacture than the pin surface applied in the pin-flange since it just requires drilling holes which is much faster and easier than milling, casting, moulding or die-sinking pins.

The embodiments herein are not limited to the above described embodiments. Various alternatives, modifications and equivalents may be used. Therefore, the above embodiments should not be taken as limiting the scope of the embodiments, which is defined by the appending claims. A feature from one embodiment may be combined with one or more features of any other embodiment.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements. The terms “consisting of” or “consisting essentially of” may be used instead of the term comprising.

The term “configured to” used herein may also be referred to as “arranged to”, “adapted to”, “capable of” or “operative to”.

It should also be emphasised that the steps of the methods defined in the appended claims may, without departing from the embodiments herein, be performed in another order than the order in which they appear in the claims.

1-18. (canceled)

19. A first waveguide comprising:
a first flange surrounding an end opening of the first waveguide;
wherein the first flange comprises at least two holes which are periodically distributed around the end opening; and
wherein the first waveguide is configured to be connected to a second waveguide by connecting the first flange to a second flange of the second waveguide such that the end opening of the first waveguide faces an end opening of the second waveguide, and such that the holes of the first flange are at least partly glide symmetrically positioned with respect to holes which are periodically distributed around the end opening of the second flange.

20. The first waveguide of claim 19, wherein the at least two holes of the first flange constitute a holey and at least partly glide symmetric Electromagnetic Band Gap (EBG) structure integrated within the first flange.

21. The first waveguide of claim 19, wherein the at least two holes of the first flange are placed in a closed shape around the end opening of the first flange.

22. The first waveguide of claim 19, wherein the at least two holes of the first flange are periodically distributed around the end opening of the first flange in at least one row.

23. The first waveguide of claim 19, wherein the first flange is located around an outer circumference of the first waveguide.

24. The first waveguide of claim 19, wherein the first waveguide is configured to be connected to the second waveguide such that a gap of zero or more is located between the first flange and the second flange when they are connected.

25. The first waveguide of claim 19, wherein each of the at least two holes of the first flange are circular, squared, and/or hexagonal shaped.

26. The first waveguide of claim 19, wherein the at least two holes of the first flange are periodically distributed around the end opening in a circular, a hexagonal, or a polygonal form.

27. A waveguide assembly for waveguides, the waveguide assembly comprising:
a first waveguide comprising a first flange surrounding an end opening of the first waveguide; wherein the first flange comprises at least two holes which are periodically distributed around the end opening of the first waveguide;
a second waveguide comprising a second flange surrounding an end opening of the second waveguide; wherein the second flange comprises at least two holes which are periodically distributed around the end opening of the second waveguide;
wherein the first and second waveguides are configured to be connected to each other by connecting the first flange to the second flanges such that the end openings face each other and such that the holes of the first flange are at least partly glide symmetrically positioned with respect to the holes of the second flange.

28. The waveguide assembly of claim 27, wherein the at least two holes of each flange constitutes a holey and at least partly glide symmetric Electromagnetic Band Gap (EBG) structure integrated within each of the first and second flanges.

29. The waveguide assembly of claim 27, wherein the at least two holes of each flange are placed in a closed shape around the respective end opening.

30. The waveguide assembly of claim 27, wherein the at least two holes of each flange are periodically distributed around the respective end opening in at least one row.

31. The waveguide assembly of claim 27:
wherein the first flange is located around an outer circumference of the first waveguide; and
wherein the second flange is located around an outer circumference of the second waveguide.

32. The waveguide assembly of claim 27, wherein a gap of zero or more is located between the first flange and the second flange when they are connected.

33. The waveguide assembly of claim 27, wherein the at least two holes of each flange are circular, squared, and/or hexagonal shaped.

34. The waveguide assembly of claim 27, wherein the at least two holes of each flange are periodically distributed around each end opening in a circular, a hexagonal, or a polygonal form.

35. A method for manufacturing a first waveguide, the method comprising:
providing a first flange surrounding an end opening to the first waveguide;
wherein the first flange comprises at least two holes which are periodically distributed around the end opening; and
wherein the first waveguide is configured to be connected to a second waveguide by connecting the first flange to a second flange of the second waveguide such that the end opening of the first waveguide faces an end opening of the second waveguide, and such that the holes of the first flange are at least partly glide symmetrically positioned with respect to holes which are periodically distributed around the end opening of the second flange.

36. A method for manufacturing a waveguide assembly for waveguides, the method comprising:
providing a first waveguide comprising a first flange surrounding an end opening of the first waveguide; wherein the first flange comprises at least two holes which are periodically distributed around the end opening of the first waveguide;
providing a second waveguide comprising a second flange surrounding an end opening of the second waveguide; wherein the second flange comprises at least two holes which are periodically distributed around the end opening of the second waveguide; and
connecting the first and second waveguides to each other by connecting the first flange to the second flange such that the end openings of the first and second waveguides face each other, and such that the holes of the first flange are at least partly glide symmetrically positioned with respect to the holes of the second flange.
